(19) United States
(12) Patent Application Publication
(10) Pub. No.: US 2008/0258483 A1
(43) Pub. Date: Oct. 23, 2008

(54) VIBRATION DAMPING BED FOR VEHICLES

(76) Inventor: Thomas Weber, Port Coquitlam (CA)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 11/737,688

(22) Filed: Apr. 19, 2007

(51) Int. Cl. B62D 24/02

(52) U.S. Cl. 296/1.03

(57) ABSTRACT

A bed comprising a bottom platform for securing to a surface of a vehicle and a horizontal riding platform coupled to the bottom platform by a horizontal motion interface which allows relative horizontal movement between the horizontal riding platform and the bottom platform. A top platform is coupled to the horizontal riding platform by a frame assembly which allows relative vertical movement between the top platform and the horizontal riding platform, such that the top platform is moveable between a lowered position and a raised position. A biasing mechanism is located between the top platform and the horizontal riding platform for selectively biasing the top platform toward the raised position.

### TECHNICAL FIELD

The invention relates to beds for vehicles, and particularly to vibration damping beds for vehicles such as trucks.

### BACKGROUND

Vehicles such as trucks which are used for long-haul shipments are often equipped with a bed located in the rear portion of the cabin. When goods need to be transported across large distances, two drivers can make the journey, with one driver sleeping while the other drives the truck. This arrangement facilitates the timely delivery of goods by allowing the truck to keep moving nearly 24 hours a day. Unfortunately, truck drivers often find it difficult to sleep while the truck is moving.

Sometimes a truck driver will pull off to the side of the road to sleep in the bed in the back of the truck. Although the truck is not moving, in cold weather the driver must typically keep the engine running to provide heat. The vibrations caused by the engine of the truck can also disturb the driver's sleep.

If a truck driver does not get enough sleep, or gets only poor quality sleep, there can be an increased risk of an accident. This endangers both the driver and other people on the road.

There exists a need for beds which can help truck drivers to get good quality sleep.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a bed comprising a bottom platform for securing to a surface of a vehicle and a horizontal riding platform coupled to the bottom platform by a horizontal motion interface which allows relative horizontal movement between the horizontal riding platform and the bottom platform. A top platform is coupled to the horizontal riding platform by a frame assembly which allows relative vertical movement between the top platform and the horizontal riding platform, such that the top platform is moveable between a lowered position and a raised position. A biasing mechanism is located between the top platform and the horizontal riding platform for selectively biasing the top platform toward the raised position.

In addition to the exemplary aspects and embodiments described above, further aspects and embodiments will become apparent by reference to the drawings and by study of the following detailed descriptions.

### BRIEF DESCRIPTION OF DRAWINGS

In drawings which illustrate non-limiting embodiments of the invention:

FIG. 1 shows a bed according to one embodiment of the invention in a raised position;

FIG. 2 shows the bed of FIG. 1 in a lowered position;

FIG. 3 shows a bottom platform section and a horizontal riding platform section of the bed of FIG. 1;

FIG. 4 shows the features between the bottom platform and the horizontal riding platform of the bed of FIG. 1;

FIG. 5 is a sectional view taken along line 5-5 in FIG. 4;

FIG. 6 shows the range of motion permitted by a bearing assembly of the bed of FIG. 1;

FIG. 7 shows the bed of FIG. 1 with the top platform removed;

FIG. 8 shows one section of the bed of FIG. 1;

FIG. 9 shows the section of FIG. 8 with the top platform section removed;

FIG. 10 shows a cover for a bed according to one embodiment of the invention;

FIG. 11 shows a portion of the cover of FIG. 10 when the bed is in a horizontally displaced position;

FIG. 12 is an expanded view of a portion of the cover of FIG. 10 when the bed is in a raised position; and,

FIG. 13 is an expanded view of a portion of the cover of FIG. 10 when the bed is in a lowered position.

### DESCRIPTION

Throughout the following description specific details are set forth in order to provide a more thorough understanding to persons skilled in the art.

However, well known elements may not have been shown or described in detail to avoid unnecessarily obscuring the disclosure. Accordingly, the description and drawings are to be regarded in an illustrative, rather than a restrictive, sense.

The invention provides a bed which is configured to be installed in a vehicle, such as for example, in the rear portion of a cabin a truck. The bed may dampen both horizontal and vertical vibrations, so that when a person is sleeping or resting on the bed, they are less likely to be disturbed by the vibrations.

In some embodiments, the bed may comprise two sections which may be separated to facilitate installation in a vehicle. Once installed, the two sections may be joined together, and a mattress may be placed atop the bed.

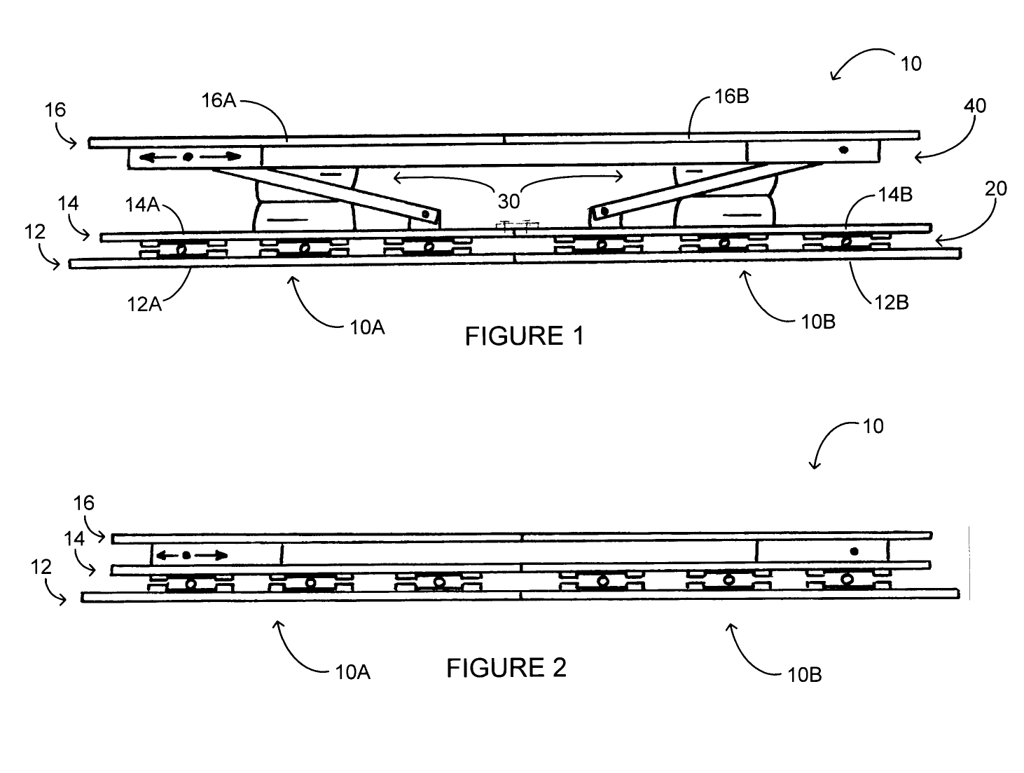

FIG. 1 shows a bed 10 according to one embodiment of the invention. Bed 10 comprises a bottom platform 12, a horizontal riding platform 14 and a top platform 16. Bed 10 comprises a first section 10A and a second section 10B. Each of bottom platform 12, horizontal riding platform 14 and top platform 16 also comprises a first section (12A, 14A and 16A) and a second section (12B, 14B and 16B). In the following description, reference numerals followed by A may be used to denote components in first section 10A, reference numerals followed by B may be used to denote components in second section 10B, and reference numerals alone may be used to collectively refer to components in both sections. In the illustrated embodiment, bed 10 comprises two sections, but it is to be understood that beds according to different embodiments could comprise different numbers of sections.

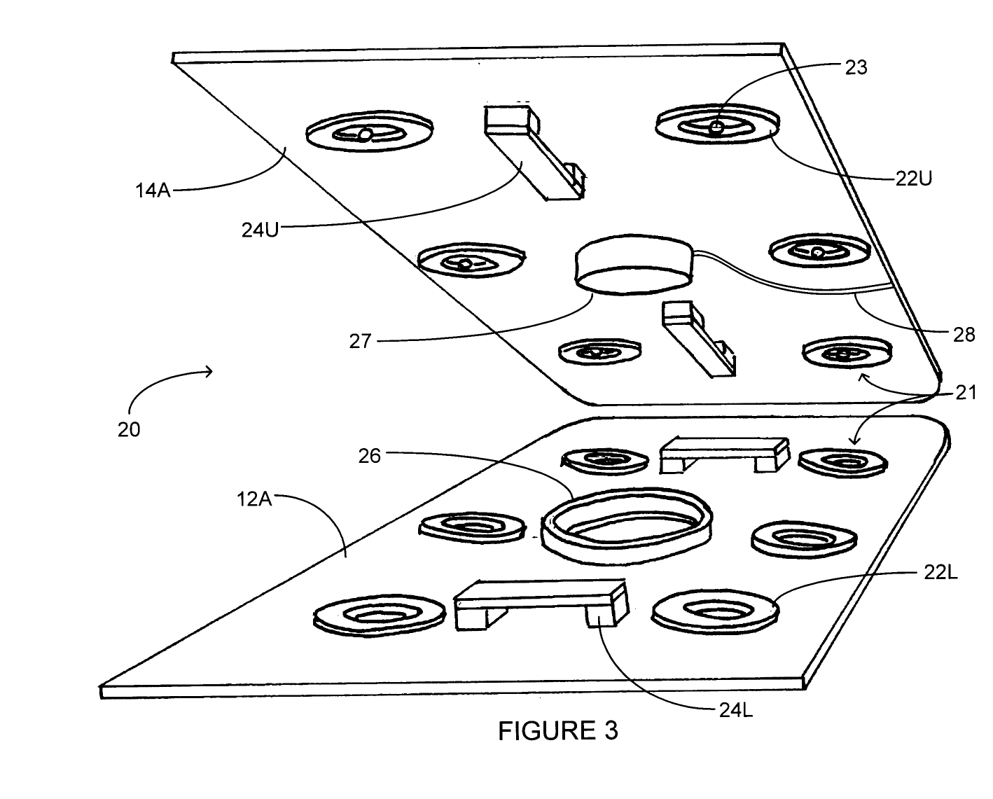

Bottom platform 12 may be secured to the body of a vehicle. A horizontal motion interface 20 is located between bottom platform 12 and horizontal riding platform 14 to allow horizontal riding platform 14 to move horizontally with respect to bottom platform 12 within a predetermined range of motion. Horizontal motion interface 20 is described further below with reference to FIGS. 3 to 6. The relative horizontal movement of horizontal riding platform 14 with respect to bottom platform 12 reduces the transfer of vibrations of the body of the vehicle to horizontal riding platform 14.

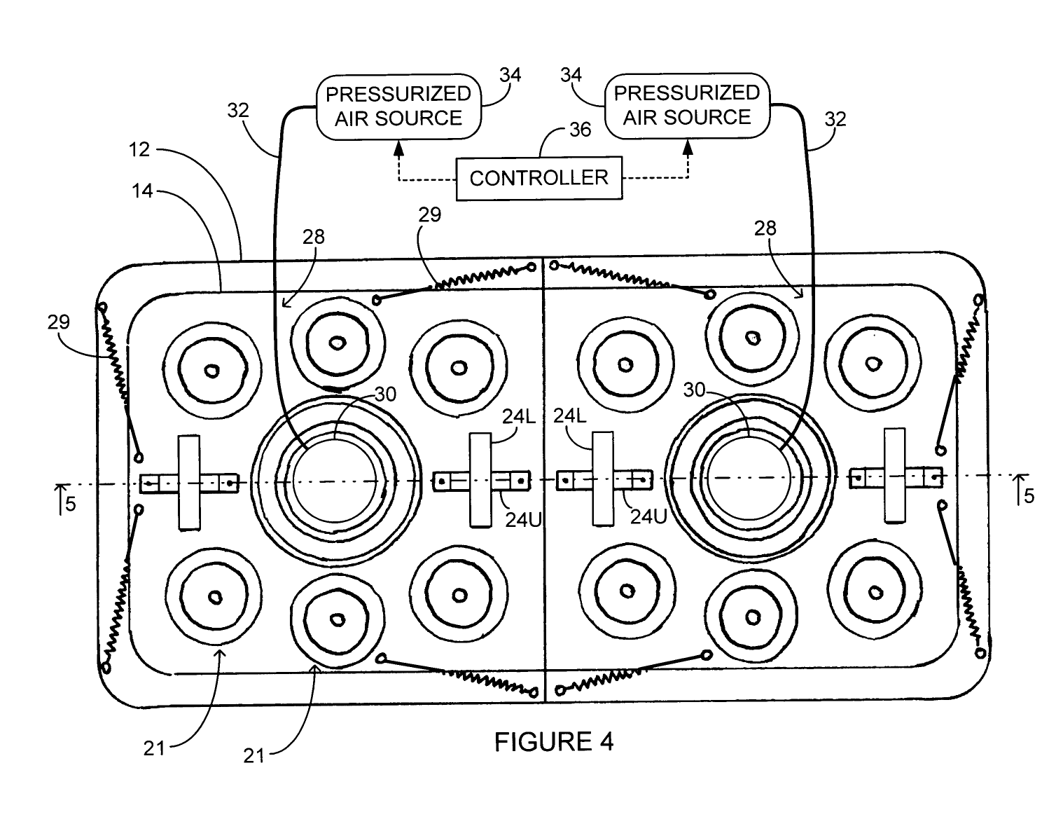

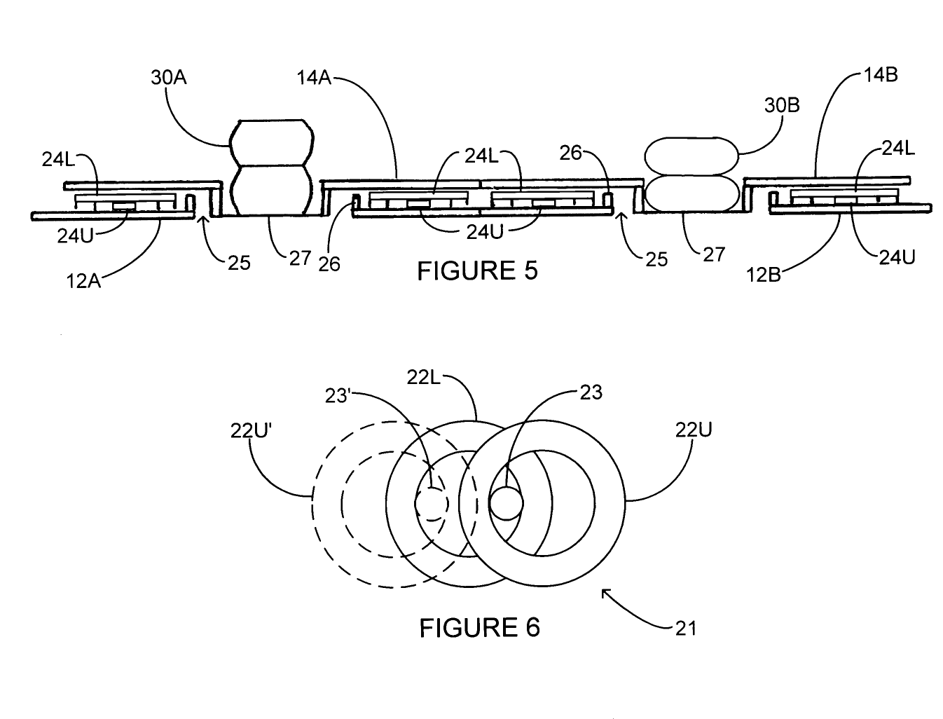

Bed 10 is moveable between a raised position, as shown in FIG. 1, and a lowered position, as shown in FIG. 2. A biasing mechanism is located between top platform 16 and horizontal riding platform 14 to selectively bias top platform 16 toward the raised position shown in FIG. 1. In the illustrated embodiment, the biasing mechanism comprises airbags 30. Additionally or alternatively, the biasing mechanism could comprise springs (not shown), although the inventor has determined that airbags are generally preferable. The pressure in airbags 30 may be individually varied to permit the angle of top platform 16 to be adjusted by the user, as described further below with reference to FIGS. 4 and 5. A frame assembly 40 is coupled between top platform 16 and horizontal riding platform 14 to define a range of vertical movement of top platform 16 with respect to horizontal riding platform 14. Frame assembly 40 is described in further detail below with reference to FIG. 7.

The components of horizontal motion interface 20 are shown in FIGS. 3 to 6. In order to facilitate illustration of components of horizontal motion interface 20, FIG. 3 shows bottom platform section 12A and horizontal riding platform section 14B separately, and FIG. 4 is a top view of bottom platform 12 and horizontal riding platform 14 with horizontal riding platform 14 depicted transparently.

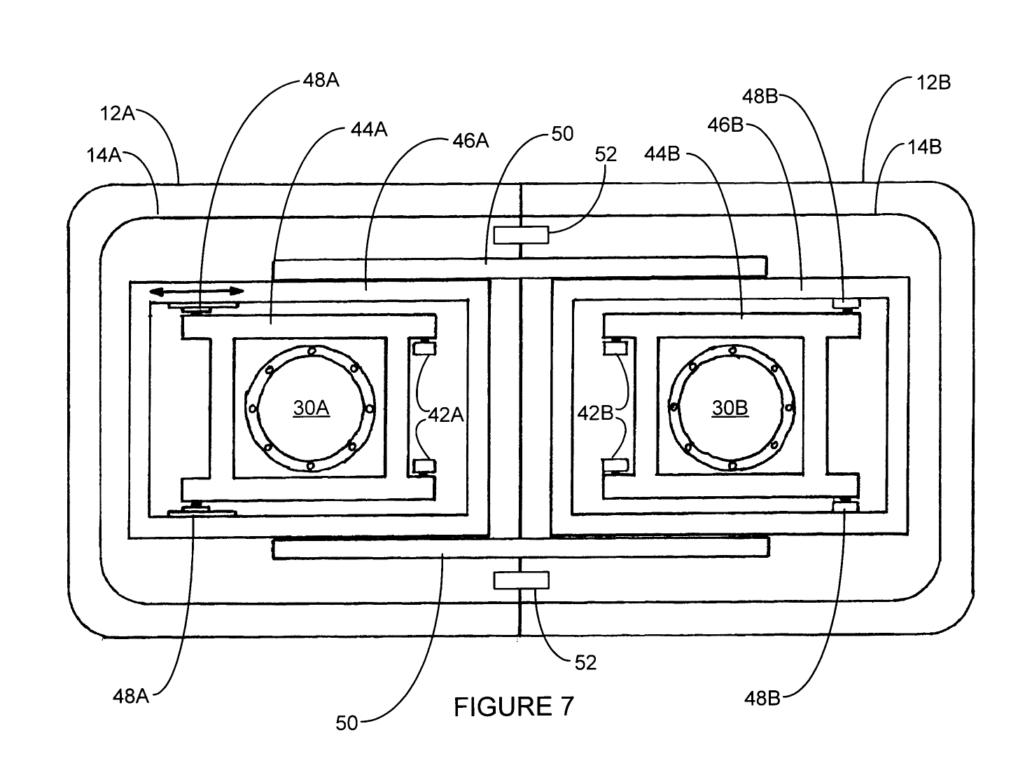

In the illustrated embodiment, horizontal motion interface 20 comprises a plurality of bearing assemblies 21. Each bearing assembly 21 comprises a lower ring 22L attached to bottom platform 12, an upper ring 22U attached to horizontal riding platform 14 and a bearing 23 therebetween. Horizontal riding platform 14 is prevented from being vertically separated more than a predetermined distance from bottom platform 12 by lower brackets 24L on bottom platform 12 which interlock with upper brackets 24U on horizontal riding platform 14. Bearings 23 are thus contained between upper and lower rings 22U and 22L (collectively, rings 22), allowing a limited range of relative motion between rings 22. Steel plates may be provided withing rings 22 to prevent bearings 23 from damaging bottom platform 12 or horizontal riding platform 14. FIG. 6 illustrates the range of motion permitted by a bearing assembly 21 along one direction in the horizontal plane. Upper ring 22U and bearing 23 can move relative to lower ring 22L between the positions indicated with solid lines in FIG. 6 and the positions indicated with dashed lines identified with reference characters 22U′ and 23′. In other embodiments, horizontal motion interface 20 could comprise a different mechanism. For example, the top of bottom platform 12 and/or the bottom of horizontal riding platform 14 could be covered with a layer of low-friction material such as silicon or the like, so that horizontal riding platform 14 may slide along the top of bottom platform 12.

An aperture 25 is defined in each section of bottom platform 12 and surrounded by a motion limiting ring 26. Apertures 25 and motion limiting rings 26 are sized to accommodate corresponding airbag nests 27 formed in horizontal riding platform 14 and allow a limited range of motion of airbag nests 27 within motion limiting rings 26. Airbag nests 27 are sized to accommodate airbags 30, such that when airbags 30 are deflated and bed 10 is in the lowered position shown in FIG. 2, frame assembly 40 can rest directly atop horizontal riding platform 14, thus minimizing the thickness of bed 10 in the lowered position. Channels 28 may be provided in horizontal riding platform 14 to accommodate hoses 32 which connect airbags 30 to pressurized air sources 34, as described below.

Springs 29 are coupled between bottom platform 12 and horizontal riding platform 14. Springs 29 bias horizontal riding platform 14 towards a neutral position shown in FIG. 4. In the neutral position, upper and lower rings 22U and 22L of each bearing assembly 21 are substantially aligned. Springs 29 may not be required in all embodiments. For example, rubber bands (not shown) may be provided around upper and lower rings 22U and 22L to bias horizontal riding platform 14 towards the neutral position. Also, in some embodiments, bed 10 may have a cover which biases horizontal riding platform 14 towards the neutral position.

Each airbag 30 is connected to a pressurized air source 34 by a hose 32. Airbags 30 may share a single pressurized air source, or may each have their own, as shown in the FIG. 4 embodiment. Pressurized air sources 34 may comprise, for example, air tanks connected to pumps. Pressurized air sources 34 may each provide an individually variable pressure to the associated airbag 30 under the control of a controller 36. Controller 36 may move bed 10 between the lowered and raised positions by varying the pressure of air supplied to airbags 30. Controller 36 may also adjust the angle of top platform 16 by providing different pressures to airbags 30, as shown in FIG. 5. Controller 36 may communicate with pressurized air sources 34 by a wired or wireless connection, and may be located in any convenient place. Alternatively, controller 36 could comprise manually operated valves for adjusting the pressures in airbags 30. In some embodiments, controller 36 could be integrated into a cover for bed 10.

FIG. 7 shows frame assembly 40 according to one embodiment. Pivoting members 44 are attached to horizontal riding platform 14 by pivots 42. Pivoting members 44 are also attached to top platform supports 46 by pivots 48. At least one set of pivots 48A and 48B are slidable to accommodate the movement of pivoting members 44 as bed 10 moves between the lowered and the raised position. In the FIG. 7 embodiment, pivots 48A are slidable, as indicated by arrow 49.

Top platform supports 46 are attached to the underside of top platform 16. The sections of top platform 16 are held together by connecting bars 50 attached between top platform supports 46A and 46B.

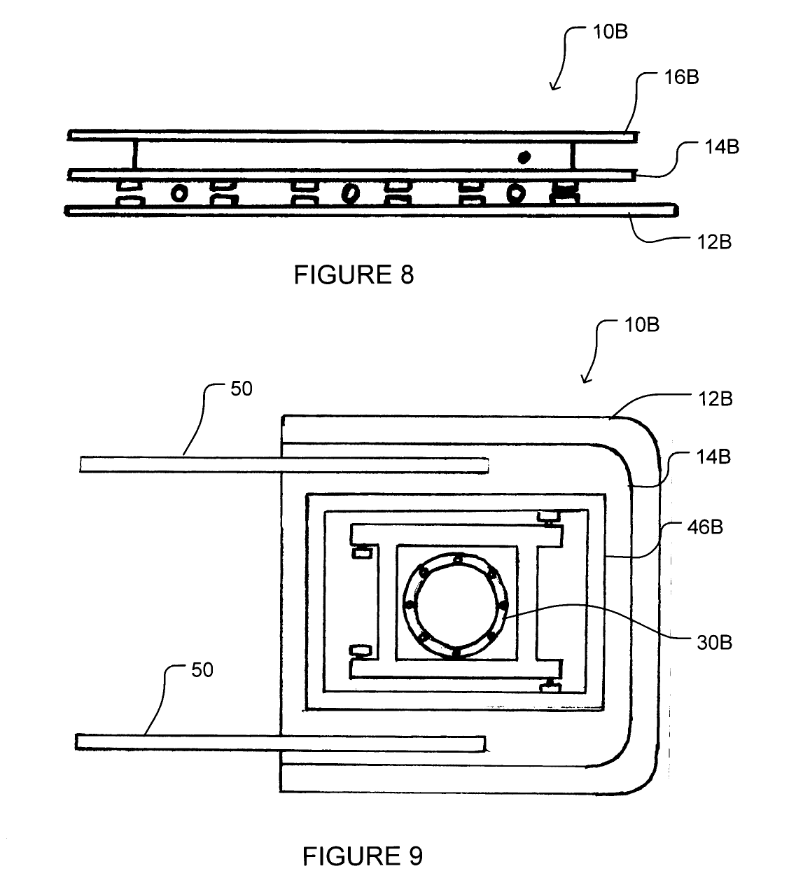

Installation of bed 10 may be facilitated by installing sections 10A and 10B one at a time. FIG. 8 is a side view of one section 10B of bed 10. FIG. 9 is a top view of section 10B with top platform section 16B depicted transparently to show that connecting bars 50 are not initially attached to top platform supports 46B during installation. A driver may install section 10B by attaching bottom platform section 12B to a surface within the vehicle, such as for example, the body in rear portion of a truck cabin. Likewise, section 10A may be installed by attaching bottom platform section 12A in a position abutting bottom platform section 12B. Connecting bars 50 may be attached between top platform supports 46 to hold top platform sections 16A and 16B together, and tie members 52 may be attached to hold horizontal riding platform sections 14A and 14B together. Airbags 30 may be connected to pressurized air sources 34 by hoses 32 (see FIG. 4) once sections 10A and 10B are in place.

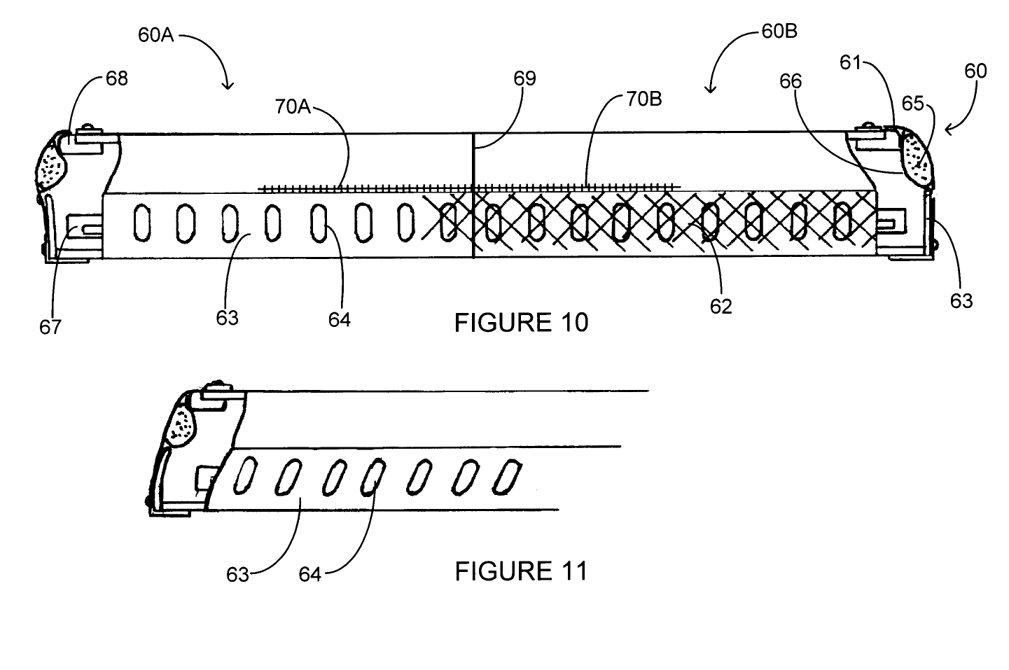

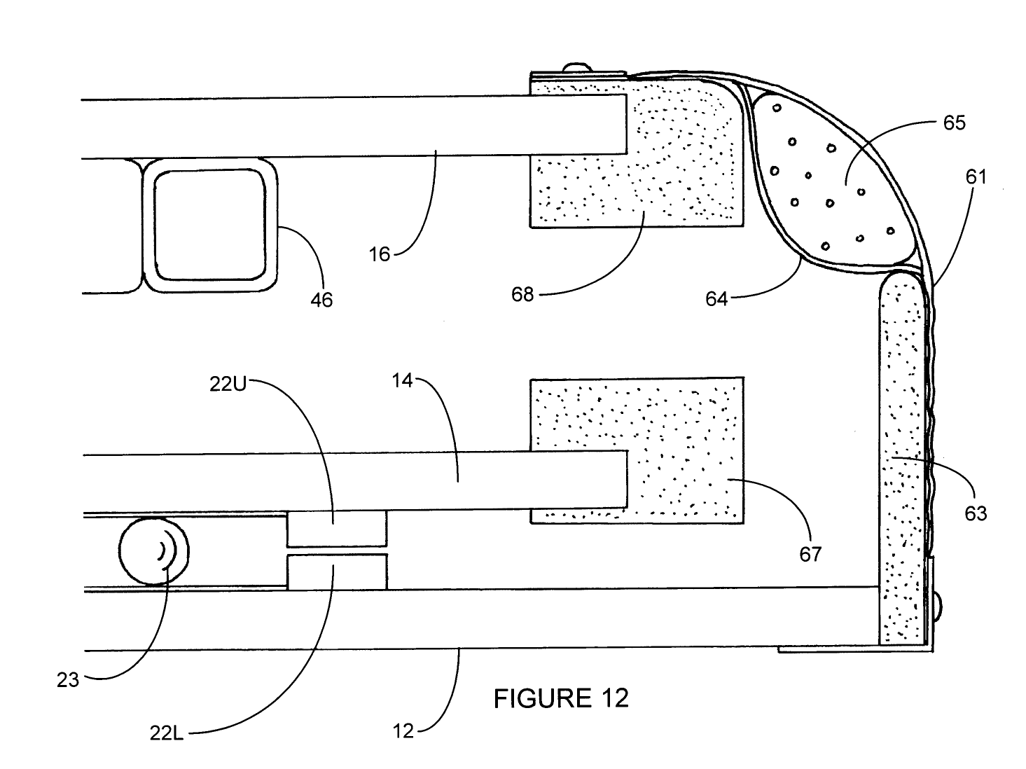

FIGS. 10 to 13 show a cover 60 which may be attached to the edges of bed 10 in some embodiments. Cover 60 prevents a user's fingers from being caught between moving components of bed 10. The portions of cover 60 near the corners of bed 10 are shown as cut away to illustrate the components of cover 60 in an example embodiment.

Cover 60 may comprise a strip 61 of material attached between top platform 16 and bottom platform 12 around the outside of bed 10. Strip 61 may comprise, for example, a mesh material, as indicated by the cross-hatching 62 shown along a portion of strip 61 in FIG. 10. A wall 63 extends upwardly from the outer edge of bottom board 12. Wall 63 may be constructed from a deformable material such as foam, sponge or the like and may define apertures 64 to facilitate deformation of wall 63 when bed 10 is horizontally displaced from the neutral position, as shown in FIG. 1. A padding member 65 is held in a sleeve 66 attached to strip 61 above wall 63. Padding member 65 may be constructed from a deformable material such as foam, sponge or the like.

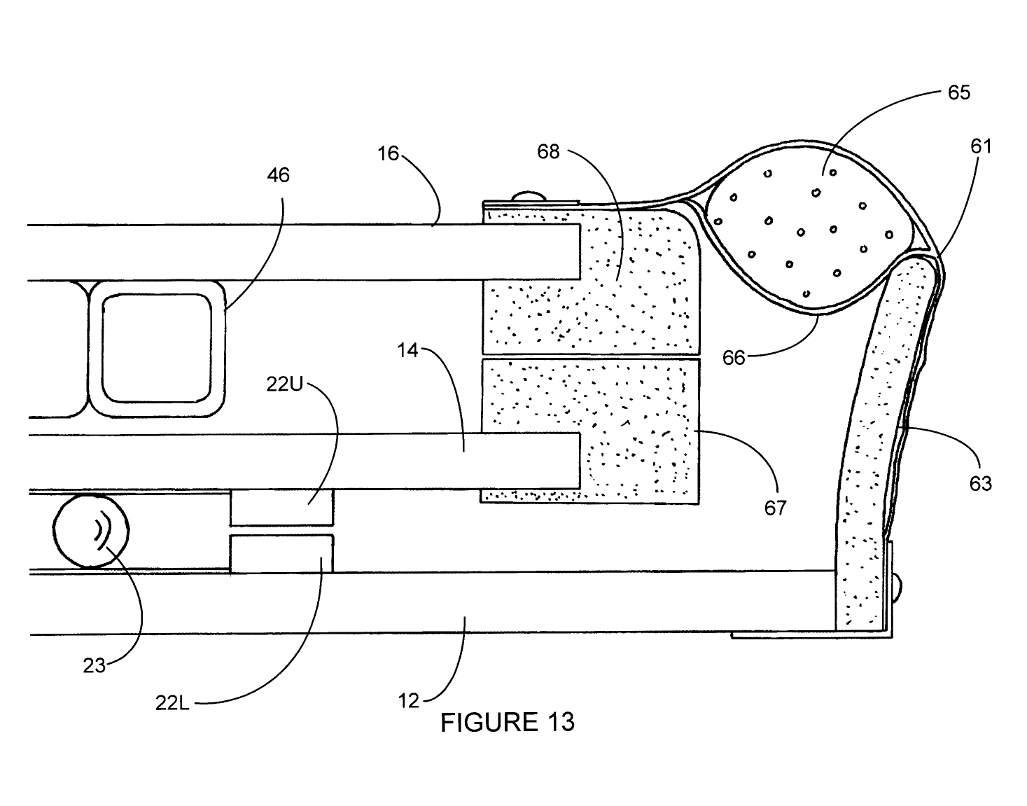

Bumpers 67 and 68 are respectively attached to the outer edges of horizontal riding platform 14 and top platform 16. Bumpers 67 and 68 may be configured to abut one another just before top platform supports 46 would contact horizontal riding platform 14 as top platform 16 moves downwardly, as shown in FIG. 13.

Cover 60 may comprise a section interface 69 which separates two cover sections 60A and 60B. Section interface 69 may comprise snaps, zippers, hook-and-loop fasteners or the like. Cover sections 60A and 60B may be respectively attached to the edges of sections 10A and 10B prior to installation. Access slits 70A and 70B may be respectively provided in cover sections 60A and 60B to facilitate access for attaching connecting bars 50 and tie members 52 during installation of bed 10. Access slits 70A and 70B may comprise, for example, zippered slits. After bed 10 has been installed, cover sections 60A and 60B may be joined together at section interface 69, and a mattress (not shown) may be placed on top of bed 10.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A bed comprising:
a bottom platform for securing to a surface of a vehicle;
a horizontal riding platform coupled to the bottom platform by a horizontal motion interface which allows relative horizontal movement between the horizontal riding platform and the bottom platform;
a top platform coupled to the horizontal riding platform by a frame assembly which allows relative vertical movement between the top platform and the horizontal riding platform, such that the top platform is moveable between a lowered position and a raised position; and,
a biasing mechanism located between the top platform and the horizontal riding platform for selectively biasing the top platform toward the raised position.

2. A bed according to claim 1 wherein the biasing mechanism comprises at least one airbag operatively coupled to a pressurized air source.

3. A bed according to claim 1 wherein the biasing mechanism comprises at least two airbags, each airbag operatively coupled to an associated pressurized air source, the bed further comprising a controller for selectively adjusting the pressure of air provided from each pressurized air source to the associated airbag.

4. A bed according to claim 1 wherein the horizontal motion interface comprises a plurality of bearing assemblies.

5. A bed according to claim 4 wherein each bearing assembly comprises a lower ring attached to the bottom platform, an upper ring attached to the horizontal riding platform, and a bearing contained between the lower ring and the upper ring.

6. A bed according to claim 5 wherein the horizontal motion interface comprises a lower bracket attached to the bottom platform and an upper bracket attached to the horizontal riding platform, wherein the lower bracket interlocks with the upper bracket to prevent the bottom platform and the horizontal riding platform from being separated more than a predetermined distance in the vertical direction.

7. A bed according to claim 4 wherein the horizontal motion interface comprises a plurality of springs connected between the bottom platform and the horizontal riding platform for biasing the horizontal riding platform towards a neutral position.

8. A bed according to claim 1 comprising a cover attached between outer edges of the top platform and the bottom platform.

9. A bed according to claim 1 wherein the bed is separable into at least two sections to facilitate installation, each section comprising a bottom platform section, a horizontal riding platform section and a top platform section.

10. A bed according to claim 9 comprising a cover section corresponding to each section of the bed, each cover section attached between outer edges of the corresponding top platform section and bottom platform section.

11. A bed according to claim 10 wherein the cover sections are joinable together by at least one section interface.

12. A bed according to claim 10 wherein each cover section defines an access slit for facilitating attachment of the sections of the bed to each other.
